(19) United States
(12) Patent Application Publication
(10) Pub. No.: US 2026/0024747 A1
(43) Pub. Date: Jan. 22, 2026

(54) ANODE ELECTRODE FOR ALL-SOLID-STATE BATTERY INCLUDING LITHIUM TIN PSEUDO-SOLID ELECTROLYTE

(71) Applicant: GM GLOBAL TECHNOLOGY OPERATIONS LLC, Detroit, MI (US)

(72) Inventors: Qili SU, Shanghai (CN); Zhe Li, Shanghai (CN)

(21) Appl. No.: 18/889,051

(22) Filed: Sep. 18, 2024

(30) Foreign Application Priority Data
Jul. 19, 2024 (CN) 2024109768227

(51) Int. Cl. H01M 4/134; H01M 4/04; H01M 4/1395; H01M 4/36; H01M 4/62

(52) U.S. Cl. CPC H01M 4/134; H01M 4/0404; H01M 4/0435; H01M 4/1395; H01M 4/364; H01M 4/623; H01M 2220/20

(57) ABSTRACT

A battery cell includes C cathode electrodes, A anode electrodes, and S separators, where A, C and S are integers greater than one. The A anode electrodes include an anode active material layer arranged on an anode current collector. The anode active material layer comprises silicon particles, lithium tin (LixSn) particles where 1<x<3.5, and a binder comprising polytetrafluoroethylene (PTFE). The binder reacts with the lithium tin particles to form amorphous carbon and lithium fluoride prior to formation.

### CROSS-REFERENCE TO RELATED APPLICATIONS

This application claims the benefit of Chinese Patent Application No. 202410976822.7 filed on Jul. 19, 2024. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to anode electrodes for battery cells.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include cathode electrodes, anode electrodes, and separators. The cathode electrodes include a cathode active material layer arranged on a cathode current collector. The anode electrodes include an anode active material layer arranged on an anode current collector.

### SUMMARY

A battery cell includes C cathode electrodes, A anode electrodes, and S separators, where A, C and S are integers greater than one. The A anode electrodes include an anode active material layer arranged on an anode current collector. The anode active material layer comprises silicon particles, lithium tin (LixSn) particles where 1<x<3.5, and a binder comprising polytetrafluoroethylene (PTFE). The binder reacts with the lithium tin particles to form amorphous carbon and lithium fluoride prior to formation.

In other features, the silicon particles are in a range from 85 to 98.9 wt % of the anode active material layer, the lithium tin particles are in a range from 1 wt % to 10 wt % of the anode active material layer, and the binder is in a range from 0.1 wt % to 5 wt %.

In other features, the silicon particles have a size in a range from 1 μm to 10 μm, and the lithium tin particles have a size in a range from 50 nm to 1 μm.

In other features, loading of the anode active material layer is in a range from 4 mAh/cm² to 30 mAh/cm², and a thickness of the anode active material layer in a range from 5 μm to 100 μm.

In other features, a softening point of the PTFE is in a range from 270° C. to 380° C., and a molecular weight of PTFE is in a range from 105 to 109 g/mol.

In other features, the silicon particles are partially lithiated to form silicon-lithium silicon (Si-LiySi) particles where 0<y<3.6.

In other features, the C cathode electrodes comprise a cathode active material layer and a cathode current collector, the cathode active material layer comprises a cathode active material and a solid electrolyte, and the S separators comprise a solid electrolyte.

In other features, the anode current collector comprises a first layer including lithium and a second layer selected from a group consisting of copper, stainless steel, titanium, and alloys thereof. The first layer has the same dimensions as the second layer.

In other features, the anode current collector includes holes. The first layer includes a plurality of lithium portions that are spaced from one another. The plurality of lithium portions have a length and width corresponding to a length and width of the A anode electrodes. The first layer includes a plurality of strips that are spaced from one another.

A method for manufacturing an anode membrane includes creating a mixture including silicon particles, lithium tin (LixSn) particles, and a binder comprising polytetrafluoroethylene (PTFE); shearing the mixture; and rolling the mixture to create an anode active material layer.

In other features, after rolling, the anode active material layer comprises silicon-lithium silicon (Si—LiySi) where 0<y<3.6, lithium tin (LixSn) where 1<x<3.5, and the binder.

In other features, the silicon-lithium silicon is a range from 85 to 98.9 wt % of the anode active material layer, the lithium tin is a range from 1 wt % to 10 wt % of the anode active material layer, and the binder is in a range from 0.1 wt % to 5 wt %. A size of the silicon particles is in a range from 1 μm to 10 μm.

A method for manufacturing an anode membrane includes creating a mixture including silicon particles, tin particles, and a binder comprising polytetrafluoroethylene (PTFE); shearing the mixture; rolling the mixture to create an anode active material layer; and pressing the anode active material layer onto an anode current collector. The anode current collector comprises a lithium layer and a layer made of at least one of copper, stainless steel, titanium, and alloys thereof.

In other features, after rolling, the anode active material layer comprises silicon-lithium silicon (Si—LiySi) where 0<y<3.6, lithium tin (LixSn) where 1<x<3.5, and the binder. The silicon-lithium silicon is a range from 85 to 98.9 wt % of the anode active material layer, the lithium tin is a range from 1 wt % to 10 wt % of the anode active material layer, a size of the silicon particles is in a range from 1 μm to 10 μm, and a size of the tin particles is in a range from 50 nm to 1 μm.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example of a battery cell including anode electrodes, cathode electrodes, and separators according to the present disclosure;

FIG. 2A is a side view of an example of an anode electrode according to the present disclosure;

FIG. 2B illustrates an example of silicon particles in a lithium tin conductive network with amorphous carbon and LiF according to the present disclosure;

FIG. 3A is a flowchart of an example of a method for manufacturing a lithium tin/silicon membrane according to the present disclosure;

FIG. 3B is a side view of an example of the lithium tin/silicon membrane according to the present disclosure;

FIG. 4A is a flowchart of an example of a method for manufacturing an anode electrode including a silicon-tin membrane arranged on a clad anode current collector according to the present disclosure;

FIG. 4B is a side view of an example of an anode electrode including a silicon-tin membrane arranged on a clad anode current collector including a lithium layer according to the present disclosure;

FIG. 4C is a functional block diagram of an example of an anode electrode including a Sn-Si membrane arranged on a clad Li/Cu anode current collector after the lithium reacts with the silicon according to the present disclosure;

FIGS. 5A to 5C are side views of an example of a battery cell including the anode electrode according to the present disclosure after manufacturing and before formation and during charging and discharging, respectively, according to the present disclosure;

FIGS. 6A to 6D are plan views of examples of clad anode current collectors according to the present disclosure;

FIG. 7 illustrates first cycle performance of a battery cell at 0.1C and room temperature with anode electrodes including silicon, Si:Sn at a ratio of 9:1, and Si:Sn at a ratio of 7:3, respectively, according to the present disclosure; and

FIG. 8 illustrates cycling performance at 0.5C and room temperature for anode electrodes including silicon, Si:Sn at a ratio of 9:1, and Si:Sn at a ratio of 7:3, respectively, according to the present disclosure.

In the drawings, reference numbers may be reused to identify similar and/or identical elements.

### DETAILED DESCRIPTION

While the battery cells are described below in the context of vehicles, the battery cells (ASSBs) can be used in other mobile or stationary applications.

Electrolyte free silicon-based anode electrodes are promising for all-solid-state batteries due to its high energy density, stable anode/electrolyte interface, and manufacturability. However, electrolyte-free silicon anode electrodes have poor cycling at higher current densities (>2 mA/cm²) due to its limited lithiation/delithiation kinetic, which leads to a formation of lithium dendrites on the surface of the anode electrode. The lithium dendrites cause the anode electrode to delaminate from an adjacent separator (e.g., solid electrolyte).

The present disclosure relates to battery including an electrolyte-free silicon-based anode electrode that includes a high ionic/electronic conductive network formed by lithium tin (LixSn) alloy particles. Based on the high electron/ion transport of LixSn, the conductive network ensures fast kinetics for silicon anode electrodes and battery cycling under higher current densities (e.g., 2 mA/cm²). As a result, the anode electrode delivers improved lithium capacity and cell cycling stability at a current rate of 0.50, which indicates that the LixSn conductive network in the anode electrode effectively improves electrode kinetics.

Referring now to FIG. 1, a battery cell 10 includes C cathode electrodes 20, A anode electrodes 40, and S separators 32 arranged in a predetermined sequence in a battery cell stack 12, where C, S and A are integers greater than zero. The battery cell stack 12 is arranged in an enclosure 50. The C cathode electrodes 20-1, 20-2, . . . , and 20-C include a cathode active material layer 24 on one or both sides of a cathode current collector 26. The A anode electrodes 40-1, 40-2, . . . , and 40-A include anode active material layers 42 arranged on one or both sides of the anode current collectors 46.

During charging/discharging, the A anode electrodes 40 and the C cathode electrodes 20 exchange lithium ions. In some examples, the cathode active material layer 24 includes coatings including one or more active materials, one or more conductive additives, and/or one or more binder materials that are cast or applied to the current collectors.

In some examples, the cathode current collector 26 comprises metal foil, metal mesh, perforated metal, 3 dimensional (3D) metal foam, and/or expanded metal. In some examples, the cathode current collectors are made of one or more materials selected from a group consisting of stainless steel, brass, bronze, zinc, aluminum, and/or alloys thereof. External tabs 28 and 48 are connected to the current collectors of the cathode electrodes and anode electrodes, respectively, and can be arranged on the same or different sides of the battery cell stack 12. The external tabs 28 and 48 are connected to terminals of the battery cells.

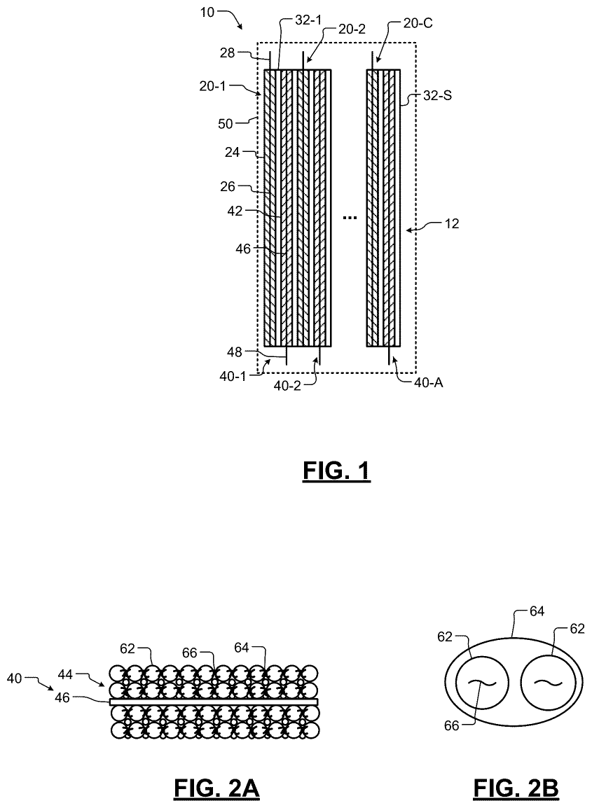

Referring now to FIGS. 2A and 2B, an example of one of the A anode electrodes 40 is shown in further detail. In some examples, the anode active material layer 44 initially includes silicon particles 62, lithium tin (LixSn) particles 64, and a binder 66 such as polytetrafluoroethylene (PTFE). After manufacturing, the Si and PTFE react with lithium. The reaction for the PTFE is 2nLi+[—CF2-]n→2nLiF+nC(amorphous). In other examples, silicon and tin particles are mixed with bonder and pressed on a clad anode current collector including a lithium layer (as will be described further below).

The Li—Sn has an electrical conductivity of about 9.1×10⁴ S/cm as compared to Li—Si at about 5×10⁻⁴ S/cm (and carbon at about 1×10⁴ S/cm). Li—Sn has a Li diffusion coefficient of about 10⁻⁸ to 10⁻⁶ cm²/s as compared to Li—Si at about 10⁻¹⁰ to 10⁻⁷ cm²/s. Based on the high electron/ion transport of LixSn, the LixSn conductive network ensures fast anode electrode kinetics and supports battery cycling under higher current density.

In some examples, the silicon particles comprise micro particles having a size in a range from 1 μm to 10 μm. In some examples, the tin particles comprise nano particles having a size in a range from 50 nm to 1 μm.

In some examples, the fibrillating binder includes PTFE. In some examples, the PTFE has a particle size in a range from 100 μm to 800 μm. In some examples, the PTFE has a particle size in a range from 300 μm to 700 μm. In some examples, a weight ratio of PTFE to the composite electrode is in a range from 0.01:100 to 20:100 (e.g., 0.05:100). In some examples, a softening point of PTFE is in a range from 270° C. to 380° C. In some examples, the molecular weight of PTFE is in a range from 105 to 109 g/mol. In some examples, water is fully removed from the binder before manufacturing the anode electrodes.

A high ionic/electronic conductive network enabled by lithium tin alloy particles is added to a partially lithiated silicon anode to boost electrode kinetics for the all-solid-state battery. After manufacturing, the electrolyte-free anode electrode includes silicon-lithium silicon (Si/LiySi) active material (e.g., where 0<=y<3.6), a lithium tin (LixSn) mix conductor (e.g., where 1<x<3.5), and a binder (e.g., PTFE producing amorphous C and LiF when exposed to lithium). LixSn particles form a high ionic/electronic conductive network. The LixSn particles are a ductile metal alloy that is soft under high pressure. LixSn and LiySi have good chemical compatibility.

In some examples, the anode electrode 40 is sulfide electrolyte-free and includes silicon in a range from 85 to 98.9 wt % (e.g., 89 wt %), LixSn in a range from 1 to 10 wt % (e.g., 10 wt %), and a fibrillating binder such as PTFE in a range from 0.1% to 5 wt % (e.g., 1 wt %). In some examples, loading is in a range from 4 mAh/cm² to 30 mAh/cm² and the thickness of the anode active material layer and/or the anode electrode is in a range from 5 μm to 100 μm.

The silicon particles provide high capacity and expand to form a compact anode electrode. The LixSn particles compensate for active lithium loss and provide high electronic/ionic conduction within the anode electrode. The fibrillating binder (including amorphous carbon and LiF when exposed to lithium) provides a good electron pathway, enables uniform lithium flux, and bonds the silicon particles and lithiated tin together.

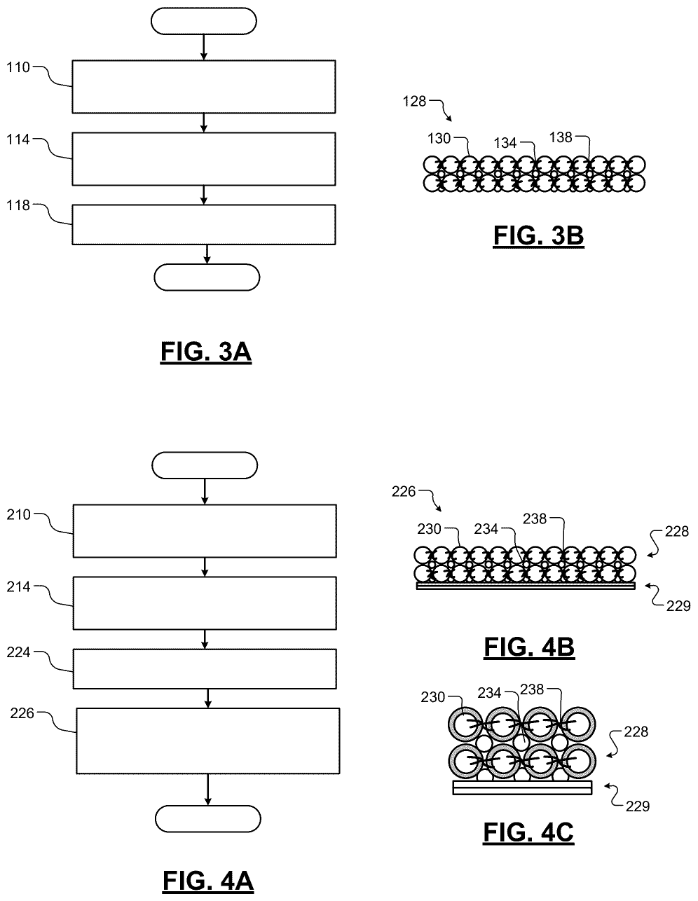

Referring now to FIGS. 3A and 3B, a method for manufacturing a LixSn-Si membrane 128 is shown. Si particles 130 are mixed with LixSn particles 138 and a fibrillating binder 134 (e.g., polytetrafluoroethylene (PTFE)) at 110. At 114, the mixture is sheared to form dry flakes. At 118, the dry flakes are rolled to form the LixSn-Si membrane 128. After manufacturing, the following reactions occur:

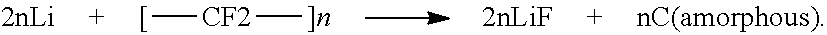

Referring now to FIGS. 4A to 4C, a method for manufacturing an anode electrode 226 including a Si—Sn membrane 228 arranged on a clad anode current collector 229 (including a lithium layer and another layer such as copper, stainless steel, titanium, and/or alloys thereof) is shown. Si particles 230 are mixed with Sn particles 234 and a fibrillating binder 238 (e.g., polytetrafluoroethylene (PTFE)) at 210. At 214, the mixture is sheared to form dry flakes. At 224, the dry flakes are rolled to form a Si—Sn membrane 228. At 226, the Si—Sn membrane 228 and the clad anode current collector 229 are rolled to form the anode electrode. The lithium in the clad anode current collector 229 causes the following reactions to occur with the silicon, tin, and/or PTFE:

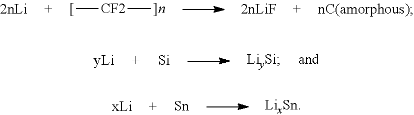

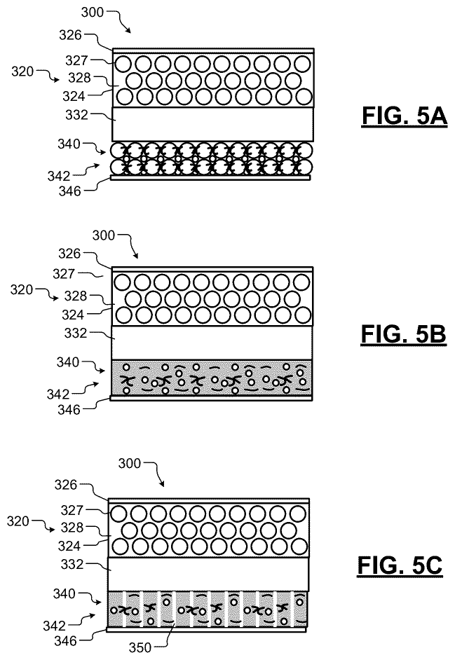

Referring now to FIGS. 5A to 5C, a battery cell 300 includes one of the anode electrodes described above. The battery cell 300 includes a cathode electrode 320, an anode electrode 340, and a separator 332. The cathode electrode 320 includes a cathode active material layer 324 and a cathode 326. The cathode active material layer 324 includes a cathode active material 327 and a solid electrolyte 328 such as a sulfide electrolyte or other types of solid electrolyte. The separator 332 includes solid electrolyte such as sulfide electrolyte or other types of solid electrolyte. The anode electrode 340 includes an anode active material layer 342 and an anode current collector 346 as described above.

In FIG. 5A, the battery cell 300 is shown after manufacturing and before formation and high pressure. In FIG. 5B, the battery cell 300 is shown after formation, application of high pressure, and charging. In FIG. 5C, the battery cell 300 is shown after discharging. In some examples, voids 350 may be created after discharging. The Sn-based alloy has good elastic/ductile properties and can form a good electrolyte-free silicon anode with a small interface between anode electrode and the separator, which enables a good cell cycling.

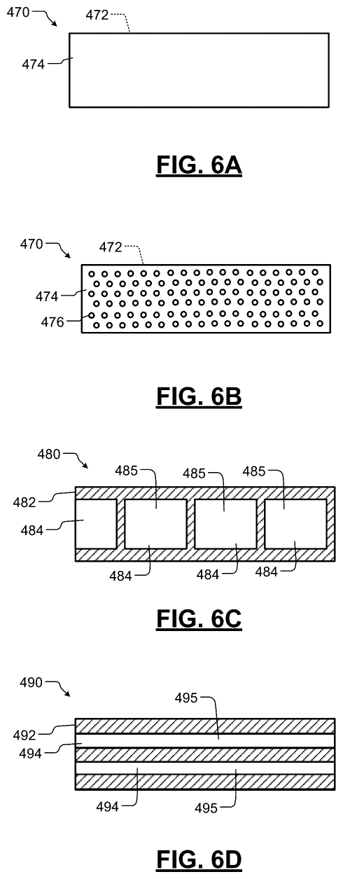

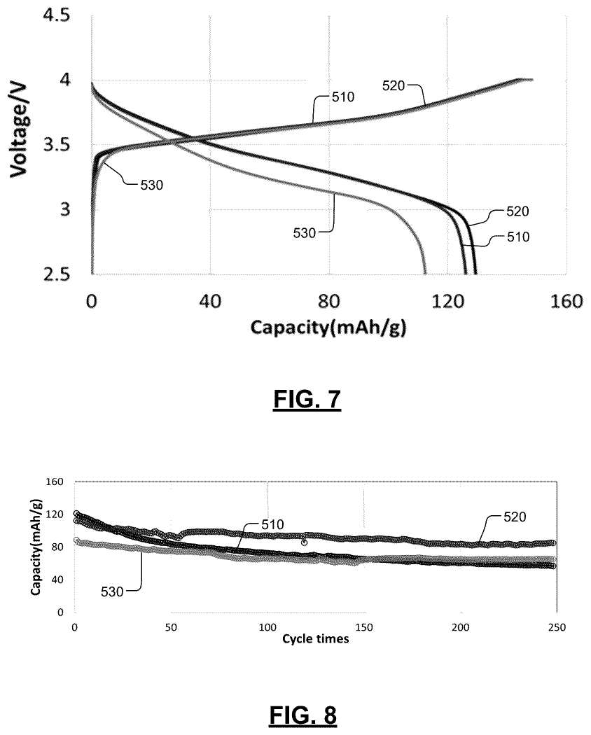

Referring now to FIG. 6A to 6D, the lithium in the composite anode current collector is used to fully react with the PTFE and partially react with silicon. In some examples, the thickness of the composite anode current collector is in a range from 2 μm to 20 μm. In addition, the stickiness of the lithium helps the dry silicon film attach to the anode current collector. In some examples, the lithium layer is attached to a copper layer to form the composite anode current collector. In other examples, the lithium layer is attached to another electrochemically inactive metal such as stainless steel, titanium or an alloy of copper, stainless steel, and/or titanium.

In FIG. 6A, an anode current collector 470 includes a first layer 472 such as copper, titanium, or stainless steel foil and a second layer 474 such as lithium foil arranged on one or both sides thereof.

In FIG. 6B, the anode current collector 470 is perforated and includes a pattern of spaced holes 478. In FIG. 6C, an anode current collector 480 includes a first layer 482 such as copper foil and a second layer 484 including discrete portions 485 made of lithium foil. In some examples, the first layer 482 is a continuous material. In some examples, the discrete portions 485 have a length and width equal to the length and width of the anode electrodes.

In FIG. 6D, an anode current collector 490 includes a first layer 492 such as copper, titanium, or stainless steel foil and a second layer 494 including strips 495 made of lithium foil. In some examples, the first layer 492 and the strips 495 are continuous. In some examples, the strips 495 are spaced from one another in a widthwise direction. In some examples, the strips 495 stop and start (e.g., in a lengthwise direction similar to the discrete portions 485 of the second layer 484) and have a length equal to the length of the anode electrodes and a width less than the width of the anode electrode. In some examples, the strips 495 extend lengthwise in the direction of the roll. In other examples, the strips extend widthwise (e.g., transverse to the lengthwise in the direction of the roll). The strips 495 allow thicker and more commercially available lithium foil (e.g., 5 to 20 μm) to be used. The spacing between the strips 495 can be determined by the thickness of the lithium strips and the desired lithiation level.

Referring now to FIGS. 7 and 8, improved performance of the battery cells including the anode electrodes are shown. In FIG. 7, first cycle performance at 0.1C and room temperature for battery cells including anode electrodes including silicon at 510, Si:Sn at a ratio of 9:1 at 520, and Si:Sn at a ratio of 7:3 at 530 is shown. In this example, the cathode active material includes NMC721/LiPSCl (7:3). The separator layer includes LiPSCl. The anode electrode includes (Si and Sn) (99 wt %), PTFE (1 wt %) and 10 wt % Li foil. In FIG. 8, cycling performance at 0.50 and room temperature for anode electrodes including silicon, Si:Sn at a ratio of 9:1, and Si:Sn at a ratio of 7:3 is shown. The high performance silicon dry film anode electrode demonstrates improved cycling performance at 0.5C current rate, which indicates that the LixSn mix conductor can effectively improve electrode kinetics.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A battery cell comprising:
C cathode electrodes;
A anode electrodes; and
S separators, where A, C and S are integers greater than one,
wherein the A anode electrodes include an anode active material layer arranged on an anode current collector,
wherein the anode active material layer comprises silicon particles, lithium tin (LiₓSn) particles where 1<x<3.5, and a binder comprising polytetrafluoroethylene (PTFE),
wherein the binder reacts with the lithium tin particles to form amorphous carbon and lithium fluoride prior to formation.

2. The battery cell of claim 1, wherein:
the silicon particles are in a range from 85 to 98.9 wt % of the anode active material layer,
the lithium tin particles are in a range from 1 wt % to 10 wt % of the anode active material layer, and
the binder is in a range from 0.1 wt % to 5 wt %.

3. The battery cell of claim 1, wherein:
the silicon particles have a size in a range from 1 μm to 10 μm, and
the lithium tin particles have a size in a range from 50 nm to 1 μm.

4. The battery cell of claim 1, wherein:
loading of the anode active material layer is in a range from 4 mAh/cm² to 30 mAh/cm², and
a thickness of the anode active material layer in a range from 5 μm to 100 μm.

5. The battery cell of claim 1, wherein:
a softening point of the PTFE is in a range from 270° C. to 380° C., and
a molecular weight of PTFE is in a range from 105 to 109 g/mol.

6. The battery cell of claim 1, wherein the silicon particles are partially lithiated to form silicon-lithium silicon (Si—LiySi) particles where 0<y<3.6.

7. The battery cell of claim 1, wherein:
the C cathode electrodes comprise a cathode active material layer and a cathode current collector,
the cathode active material layer comprises a cathode active material and a solid electrolyte, and
the S separators comprise a solid electrolyte.

8. The battery cell of claim 6, wherein the anode current collector comprises a first layer including lithium and a second layer selected from a group consisting of copper, stainless steel, titanium, and alloys thereof.

9. The battery cell of claim 8, wherein the first layer has the same dimensions as the second layer.

10. The battery cell of claim 8, wherein the anode current collector includes holes.

11. The battery cell of claim 8, wherein the first layer includes a plurality of lithium portions that are spaced from one another.

12. The battery cell of claim 11, wherein the plurality of lithium portions have a length and width corresponding to a length and width of the A anode electrodes.

13. The battery cell of claim 8, wherein the first layer includes a plurality of strips that are spaced from one another.

14. A method for manufacturing an anode membrane, comprising:
creating a mixture including silicon particles, lithium tin (LiₓSn) particles, and a binder comprising polytetrafluoroethylene (PTFE);
shearing the mixture; and
rolling the mixture to create an anode active material layer.

15. The method of claim 14, wherein, after rolling, the anode active material layer comprises silicon-lithium silicon (Si—LiySi) where 0<y<3.6, lithium tin (LiₓSn) where 1<x<3.5, and the binder.

16. The method of claim 15, wherein:
the silicon-lithium silicon is a range from 85 to 98.9 wt % of the anode active material layer,
the lithium tin is a range from 1 wt % to 10 wt % of the anode active material layer, and
the binder is in a range from 0.1 wt % to 5 wt %.

17. The method of claim 14, wherein a size of the silicon particles is in a range from 1 μm to 10 μm.

18. A method for manufacturing an anode membrane, comprising:
creating a mixture including silicon particles, tin particles, and a binder comprising polytetrafluoroethylene (PTFE);
shearing the mixture;
rolling the mixture to create an anode active material layer; and
pressing the anode active material layer onto an anode current collector,
wherein the anode current collector comprises a lithium layer and a layer made of at least one of copper, stainless steel, titanium, and alloys thereof.

19. The method of claim 18, wherein, after rolling, the anode active material layer comprises silicon-lithium silicon (Si—LiySi) where 0<y<3.6, lithium tin (LixSn) where 1<x<3.5, and the binder.

20. The method of claim 19, wherein:
the silicon-lithium silicon is a range from 85 to 98.9 wt % of the anode active material layer,
the lithium tin is a range from 1 wt % to 10 wt % of the anode active material layer,
a size of the silicon particles is in a range from 1 μm to 10 μm, and
a size of the tin particles is in a range from 50 nm to 1 μm.
